(19) United States
(12) Patent Application Publication
(10) Pub. No.: US 2012/0278640 A1
(43) Pub. Date: Nov. 1, 2012

(54) WORKSTATION WITH OCCUPANCY SENSING

(75) Inventor: Vincent John Caglianone, Tigard, OR (US)

(73) Assignee: LEVITON MANUFACTURING CO., INC., Melville, NY (US)

(21) Appl. No.: 13/095,710

(22) Filed: Apr. 27, 2011

(51) Int. Cl. G06F 1/32; G06F 1/26

(52) U.S. Cl. 713/323; 713/300

(57) ABSTRACT

An occupancy sensing method includes monitoring a space associated with a computer workstation for an occupant, generating an occupancy signal in response to monitoring the space, processing the occupancy signal at the computer workstation, and performing one or more power management functions at the computer workstation in response to the occupancy signal. The space associated with the computer workstation may be monitored by an occupancy sensor coupled to the computer workstation. The occupancy sensor may be adjusted from the computer workstation. A request may be transmitted from the computer workstation to a building automation system in response to the occupancy signal, and the building automation system may perform a power management function in response to the request from the computer workstation.

### BACKGROUND

Computer workstations typically include internal power management features that can be configured to turn off various pieces of hardware to reduce power consumption when the workstation is not being used. The internal power management features built into workstations operate on the assumption that the workstation is no longer in use when no user inputs in the form of key presses or mouse movements have been received for a predetermined period of time. For example, the operating system may be configured to turn off the display after 20 minutes with no key presses, turn off the hard drive after 30 minutes with no key presses, and place the CPU in a suspend, sleep or hibernate mode after 60 minutes with no key presses. The operating system may also be configured to lock down the workstation and require the user to re-enter a password after any of these power management actions take place.

Basing power management decisions on the amount of time without user inputs to the workstation, however, often leads to incorrect assumptions that result in devices being turned off and/or the workstation being locked down while the user is still present at the workstation. Moreover, if the user does leave the workstation shortly after the last user input action, the workstation may be left unattended, fully powered, and unsecured during the entire time-out periods set for the various components.

### SUMMARY

A method may include providing an occupancy sensor coupled via a connection to a computer workstation, monitoring a space associated with the computer workstation with the occupancy sensor, generating an occupancy signal in response to monitoring the space, transmitting the occupancy signal to the computer workstation, processing the occupancy signal with a central processing unit of the computer workstation, and performing one or more power management functions at the computer workstation in response to the occupancy signal.

The one or more power management functions may include an internal power management function, which includes at least one of turning off a display of the computer workstation, turning off a hard drive of the computer workstation, turning off the central processing unit of the computer workstation, and putting the workstation in a sleep mode.

The connection between the occupancy sensor and the computer workstation may be a hard wire. The connection between the occupancy sensor and the computer workstation may be via a wireless connection. Performing the one or more power management functions may include controlling a power switch coupled via a connection to the computer workstation. The occupancy signal may be received by the computer workstation through a USB port.

The one or more power management functions may include an external power management function. The external power management function may include turning off power to an electrical receptacle, which may be included in a power strip. The external power management function may include controlling a peripheral device having built-in power management capability.

The external power management function comprises communicating with a building automation system. Communicating with the building automation system may include requesting the building automation system to turn off lighting for the space associated with the computer workstation.

The space associated with the computer workstation may be monitored by an occupancy sensor mounted to a display for the computer workstation. The occupancy sensor may include two or more ultrasonic sensors, and the method may further include providing different weighting to outputs from the transducers, thereby adjusting the coverage pattern of the occupancy sensor.

The method may further include adjusting a parameter of the occupancy sensor at the computer workstation. The method may further include monitoring data via a load monitoring apparatus coupled to the computer workstation via a connection. The parameter of the occupancy sensor may be adjusted through a dialog box at the computer workstation.

A method may include monitoring a space associated with a computer workstation using an occupancy sensor coupled to the computer workstation, generating an occupancy signal in response to monitoring the space, processing the occupancy signal at the computer workstation, and adjusting the occupancy sensor from the computer workstation.

The method may further include performing one or more power management functions at the computer workstation in response to the occupancy signal. Adjusting the occupancy sensor from the computer workstation may include receiving input from a user at the workstation, adjusting a parameter of the occupancy sensor in response to the input, and transmitting the adjusted parameter from the workstation to the occupancy sensor. The parameter may include sensitivity for the occupancy sensor. The method may further include receiving a wake input at the occupancy sensor, and transmitting the wake input to the workstation. The parameter may include a sensitivity for the occupancy sensor, and the method may further include increasing the sensitivity for the occupancy sensor in response to receiving the wake input.

A method may include monitoring a space associated with a computer workstation for an occupant, generating an occupancy signal in response to monitoring the space, transmitting a request from the computer workstation to a building automation system in response to the occupancy signal, and performing one or more power management functions with the building automation system in response to the request from the computer workstation. The one or more power management functions may include controlling a light for the space associated with the computer workstation. The method may further include overriding a blink warn operation in response to the request. The method may further include overriding a sweep operation in response to the request.

### BRIEF DESCRIPTION OF THE DRAWINGS

FIG. 1 illustrates an embodiment of an occupancy sensing system according to some inventive principles of this patent disclosure.

FIG. 2 illustrates another embodiment of an occupancy sensing system according to some inventive principles of this patent disclosure.

FIG. 3 illustrates another embodiment of an occupancy sensing system according to some inventive principles of this patent disclosure.

FIG. 4 illustrates another embodiment of an occupancy sensing system according to some inventive principles of this patent disclosure.

FIG. 5 illustrates an embodiment of a computer workstation according to some inventive principles of this patent disclosure.

FIG. 6 illustrates an exemplary embodiment of a computer workstation according to some inventive principles of this patent disclosure.

FIG. 7 illustrates an embodiment of a dialog box for implementing a user interface according to some inventive principles of this patent disclosure.

FIG. 8 is a block diagram of an embodiment of an occupancy sensor according to some inventive principles of this patent disclosure.

FIG. 9 is a block diagram of an embodiment of a power strip according to some inventive principles of this patent disclosure.

FIG. 10 is a perspective view of an example embodiment of an occupancy sensor according to some inventive principles of this patent disclosure.

FIG. 11 is a perspective view of an example embodiment of a power strip according to some inventive principles of this patent disclosure.

FIGS. 12 and 13 illustrate the coverage pattern of the occupancy sensor of FIG. 10.

FIG. 14 is a top plan view of a workspace associated with another embodiment of a workstation occupancy sensing system according to some inventive principles of this patent disclosure.

FIG. 15 illustrates another embodiment of an occupancy sensing system according to some inventive principles of this patent disclosure.

### DETAILED DESCRIPTION

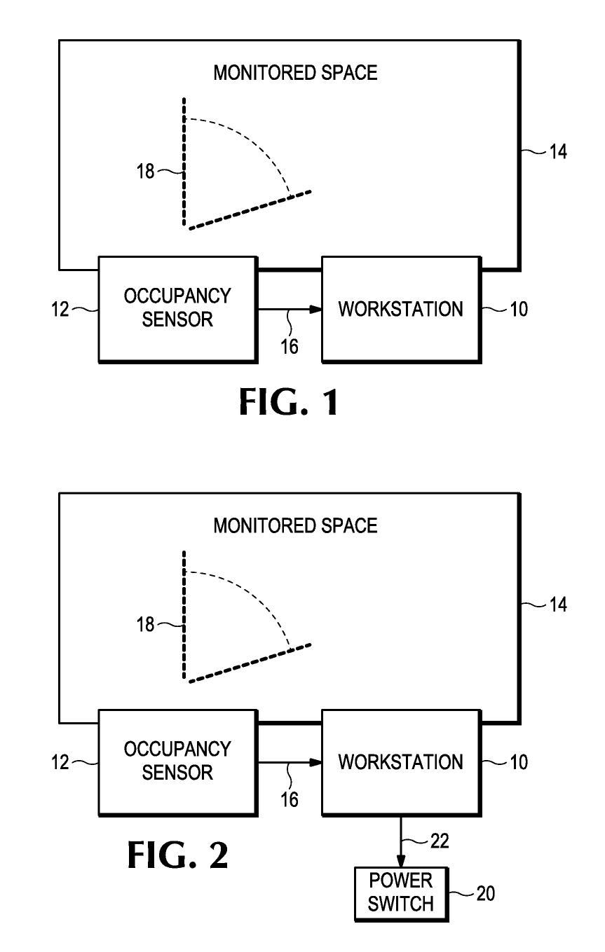

FIG. 1 illustrates an embodiment of an occupancy sensing system according to some inventive principles of this patent disclosure. The embodiment of FIG. 1 includes a computer workstation 10 and an occupancy sensor 12 arranged to monitor a space 14 associated with the computer workstation for one or more occupants. The occupancy sensor 12 generates an occupancy signal in response to monitoring the space. A connection 16 between the occupancy sensor and the computer workstation enables the computer workstation 10 to process the occupancy signal and perform one or more power management functions in response to the occupancy signal.

A computer workstation (or “computer” or “workstation”) refers to a combination of input, output, and computing hardware that can be used for work or entertainment by an individual, and includes desktop computers, notebook computers, terminals connected to networks, etc. The computing hardware may include a central processing unit (CPU) to execute program instructions. The workstation may process the occupancy signal from the occupancy sensor with software that uses CPU cycles to perform its functions. Processing the occupancy signal may be performed as a low priority process on the CPU. Implementing the occupancy signal processing as a low priority process may integrate well with other CPU processes because, if the workstation is in use and other higher priority process are running, there is no concern that the low priority occupancy signal processing is slowed down. However, if the occupancy sensor is checking for occupancy, then the workstation is unlikely to be in use, and free CPU cycles are available. Moreover, processing the occupancy signal with workstation CPU cycles may also enable the processing power of the occupancy sensor to be reduced, thereby reducing its cost.

The occupancy sensor 12 has a field of view 18 that enables it to monitor the space 14 associated with the computer workstation. The occupancy sensor 12 may be based on any suitable sensing technology such as passive infrared (PIR), ultrasonic (U/S), audio, video, etc., or any combination thereof.

The connection 16 between the occupancy sensor and the workstation may be implemented with any suitable wired or wireless connection including, but not limited to, those known as Universal Serial Bus (USB), RS-232, IEEE-1394 (Firewire), Bluetooth, Zigbee, etc.

In the embodiment of FIG. 1, the power management functions that may be performed by the workstation include, but are not limited to, turning off a display (monitor), hard drive, CPU, etc., putting the workstation in a sleep, hibernate, or suspend mode, etc.

FIG. 2 illustrates another embodiment of an occupancy sensing system according to some inventive principles of this patent disclosure. The embodiment of FIG. 2 is similar to the embodiment of FIG. 1 but further includes a power switch 20 and a control connection 22 between the workstation 10 and power switch 20 that enables the workstation to perform additional power management functions in response to the occupancy signal from occupancy sensor 12. The power switch 20 may be implemented with a hard-wired switching device, a plug-in power strip, a built-in power switch on a peripheral device having the ability to respond to the control connection 22, etc.

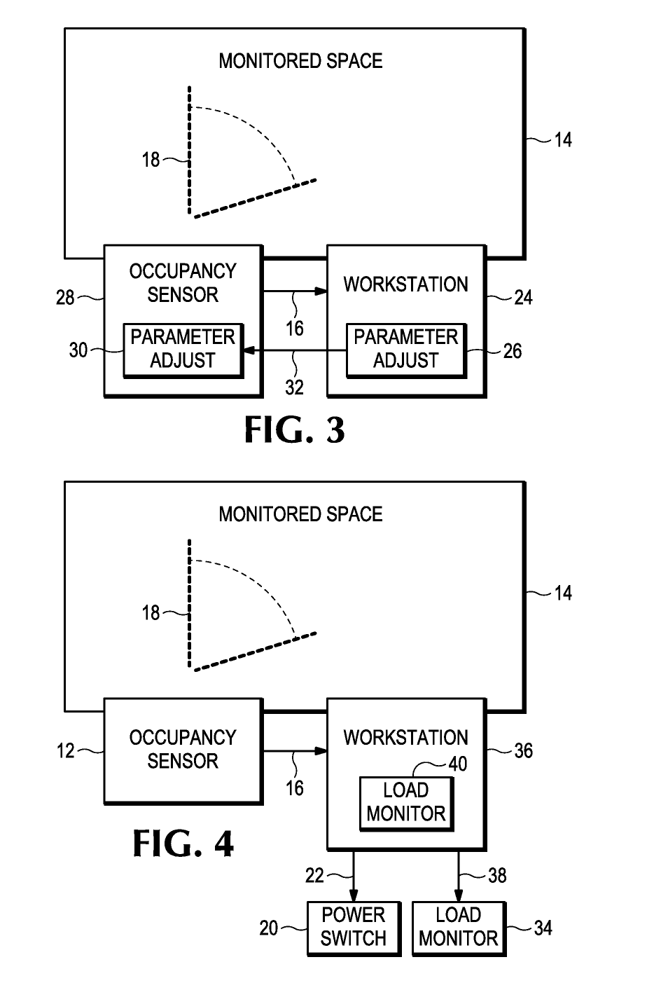

FIG. 3 illustrates another embodiment of an occupancy sensing system according to some inventive principles of this patent disclosure. The embodiment of FIG. 3 is similar to the embodiment of FIG. 1 but in the embodiment of FIG. 3, the workstation 24 includes functionality 26 that enables a user to adjust a parameter of the occupancy sensor at the workstation. The occupancy sensor 28 includes functionality 30 that enables the occupancy sensor to accept an adjusted parameter from the workstation through a connection 32.

The adjustable parameter may include a time-out delay, sensitivity setting, etc., for the occupancy sensor. The connection 32 may be integral with the connection 16 that carries the occupancy signal, or it may be a separate connection.

FIG. 4 illustrates another embodiment of an occupancy sensing system according to some inventive principles of this patent disclosure. The embodiment of FIG. 4 is similar to the embodiment of FIG. 2 but the embodiment of FIG. 4 includes load monitoring apparatus 34 that enables the workstation 36 to monitor one or more loads through a connection 38 to the workstation. The load monitoring apparatus 34 may be separate from, or integral with, power switch 20, and enables the workstation to determine power, voltage and/or current levels, as well as on/off status and other parameters of an electrical load. The workstation 36 includes load monitoring functionality 40 that enables collection, storage, display, etc., of data collected from the load monitoring apparatus 34.

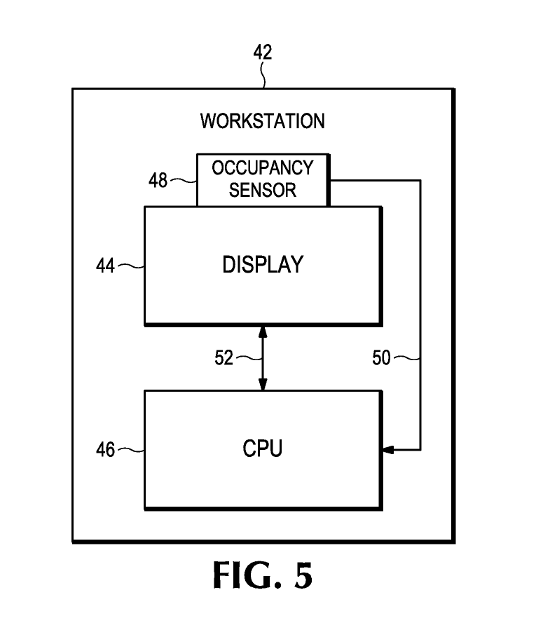

FIG. 5 illustrates an embodiment of a computer workstation according to some inventive principles of this patent disclosure. The workstation 42 of FIG. 5 includes a display 44 and a CPU 46. An occupancy sensor 48 is mounted to the display to facilitate monitoring the space associated with the workstation. The occupancy sensor 48 may be separate from, or integral with, the display 44, and may be based on any suitable sensing technology. The occupancy sensor 48 generates an occupancy signal which is transmitted to the CPU 46 through a connection 50, which may be implemented with any suitable wired or wireless connection. The connection 50 may be a separate connection as illustrated in FIG. 5, or it may be implemented as part of the connection 52 between the display 44 and CPU 46.

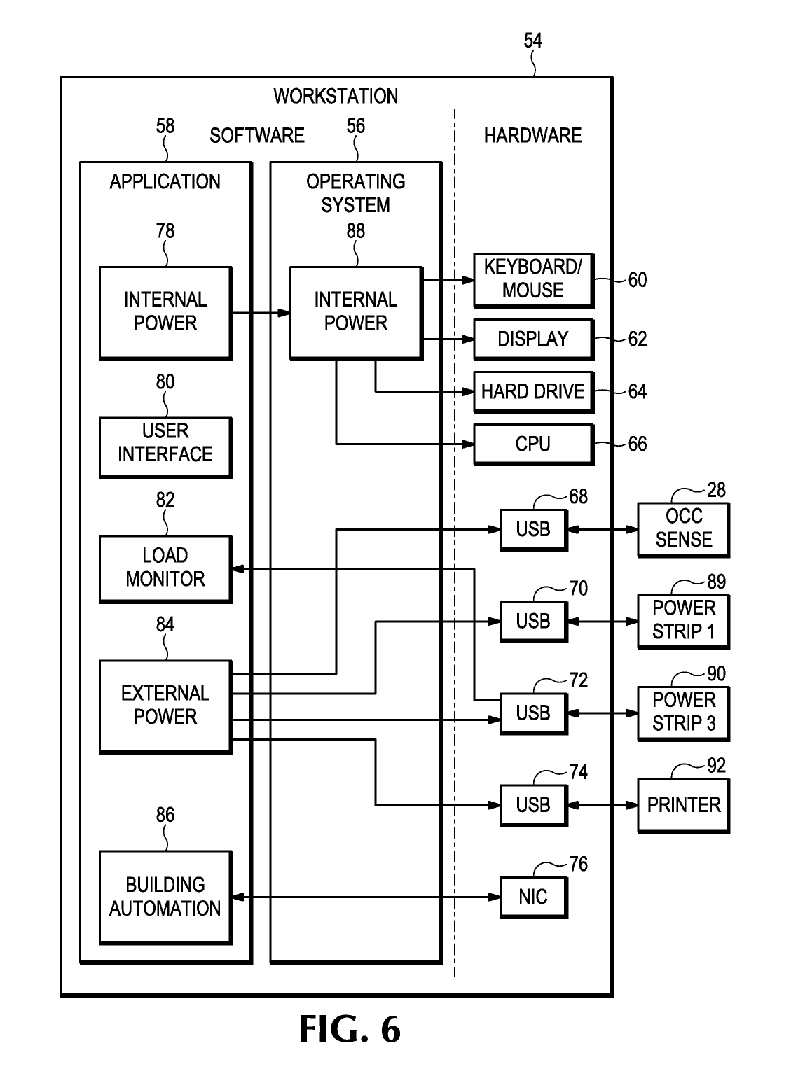

FIG. 6 illustrates an exemplary embodiment of a computer workstation according to some inventive principles of this patent disclosure. The workstation 54 is shown divided into hardware and software components. The software side is further divided into an operating system 56 and an application program 58 for implementing the inventive features relating to occupancy sensing, power management, power monitoring, etc. The hardware side includes a keyboard/mouse/touchpad 60, display (monitor) 62, hard drive 64, CPU 66, USB ports 68, 70, 72 and 74 and a network interface card (NIC) 76.

The application software 58 interacts with the hardware through the operating system 56 which includes drivers for input/output services and lower-level functionality that enable the application software to concentrate on higher level decision making The application software may include code that implements any or all of the following functionality: internal power management 78, user interface 80, load monitoring and reporting 82, external power management 84 and interaction with lighting control systems and/or other building automation and control systems 86.

As explained above, the operating system 56 typically includes internal power management features 88 that can be configured to turn off various pieces of hardware to reduce power consumption when the workstation is not being used. The internal power management features 88 built into the operating system work on the assumption that the workstation is no longer in use when no user inputs in the form of key presses or mouse movements have been received for a predetermined period of time. Basing power management decisions on the amount of time without user inputs to the workstation, however, often leads to incorrect assumptions that result in devices being turned off and/or the workstation being locked down while the user is still present at the workstation. Moreover, if the user does leave the workstation shortly after the last user input action, the workstation may be left unattended, fully powered, and unsecured during the entire time-out periods set for the various components.

The application software 58 may include internal power management functionality 78 that makes decisions in response to the actual presence or absence of a user at the workstation rather than assumptions based on the amount of time without user input actions. The internal power management functionality 78 determines the state of an occupancy signal from an occupancy sensor 28 through a USB port 68 and uses this information to make decisions on when to turn off power to various pieces of hardware, place the workstation in a suspend, sleep or hibernate mode, and/or lock down the workstation and require the user to re-enter a password. Thus, the internal power management functionality 78 of the application software 58 may replace or supplement the internal power management features 88 built into the operating system 56.

Using an occupancy sensor to control the internal power management functions of a workstation may reduce power consumption and/or improve workstation security. For example, occupancy sensors that use ultrasonic sensing technology tend to have good sensitivity to the “small motions” that are typical of a person working at a desktop, and therefore, may provide an accurate indication of the presence of an occupant at a workstation. Therefore, the timeout delay for the occupancy sensor 28 may be set to a relatively short amount of time, e.g., a few minutes, without producing false indications of an unoccupied condition at the workstation. This may result in reduced power consumption and improved security because the display, hard drive and other hardware may be turned off and the workstation locked down shortly after the user leaves the workstation. Moreover, the use of an occupancy sensor to control the internal power management functions of a workstation may reduce or eliminate instances in which hardware is turned off and/or the workstation locked down even though the user is still present at the workstation.

The application software 58 may also include external power management functionality 84 which enables the workstation to control external hardware in response to occupancy sensor 28. In the example of FIG. 6, power strips 89 and 90 are connected to workstation 54 through USB ports 70 and 72, respectively, and include power switches that can turn off power to one or more switched receptacles, and therefore, turn off power to any equipment that is plugged into the switched receptacles in response to external power management functionality 84. Other equipment having built-in power management capability may also be controlled by the external power management functionality 84. For example, a printer 92 may be configured to power down or enter some other low power mode, e.g., turning off power to a fuser, in response to one or more commands received through USB port 74 when the occupancy sensor 28 determines that no user is present at the workstation 54.

The application software 58 may also include load monitoring functionality 82 that enables the application software to collect, record, store, display, report, etc., load data collected from any internal or external hardware that is capable of monitoring power consumption such as the load monitoring apparatus 34 shown in FIG. 4.

The application software 58 may also include software to interface the workstation to a lighting control system or other building automation system through the network interface card 76 or through any other suitable interface.

User interface software 80 enables a user to configure any or all of the features of the application software 58. For example, the user interface may include one or more dialog boxes having menus, slider bars, check boxes, radio buttons, or other interface mechanisms that enable a user to set the sensitivity, time-out delay, coverage area, etc., of the occupancy sensor 28 if the occupancy sensor is of the type that can receive adjustable parameters through the USB port 68.

The user interface software 80 may also enable a user to configure which internal and external power management actions to take in response to the occupancy sensor 28 such as turning off the display 62 or hard drive 64, placing the workstation in a low power mode such as sleep, suspend, hibernate, etc., locking down the workstation with password protection, turning off switched receptacles in one or more power strips 89 and 90, turning off external equipment with built in power management capability such as printer 92, or communicating with a lighting control system or other building automation system through the network interface card.

The user interface may also enable the user to configure the application software to turn off internal or external hardware immediately upon receiving an unoccupied indication from the occupancy sensor, or after one or more additional time delays. Various additional time delays may be used to stagger the times at which different pieces of hardware are turned off, as well as when they are turned back on to prevent excessive power surges when the presence of an individual at the workstation is detected again.

The user interface may also enable a user to process and/or view the power consumption of the workstation and/or any peripherals having power monitoring capability in real time, as well has historical records of power consumption to look for patterns that may provide indications of how to achieve further energy savings. The user interface may also enable the user to configure the system to report power consumption data to a lighting control system or other building automation system for further processing and analysis.

The application software may be implemented with an application programming interface (API), thereby enabling it to hook, and be hooked by, other software. Some of the application software functionality may be implemented with a user interface that is similar to a standard screensaver, and one or more portions of the application software may be selected from a screen saver portion of the operating system. However, the configuration and other hooks may be particular to the occupancy sensing and power switching devices and their own resident programs.

The inventive principles are not limited to example implementation details shown in FIG. 6. For example, the connections made through the USB ports and NIC may be implemented with wireless connections such as Bluetooth, or may use alternative wired connections such as DisplayPort or HDMI connections. Power line communication (PLC) connections may be used to communicate with power switches in power strips or in switched receptacles located in wiring devices near the workstation. Moreover, switched power receptacles may be integrated directly into the workstation to control power to peripheral devices in response to an occupancy sensor that is connected to the workstation.

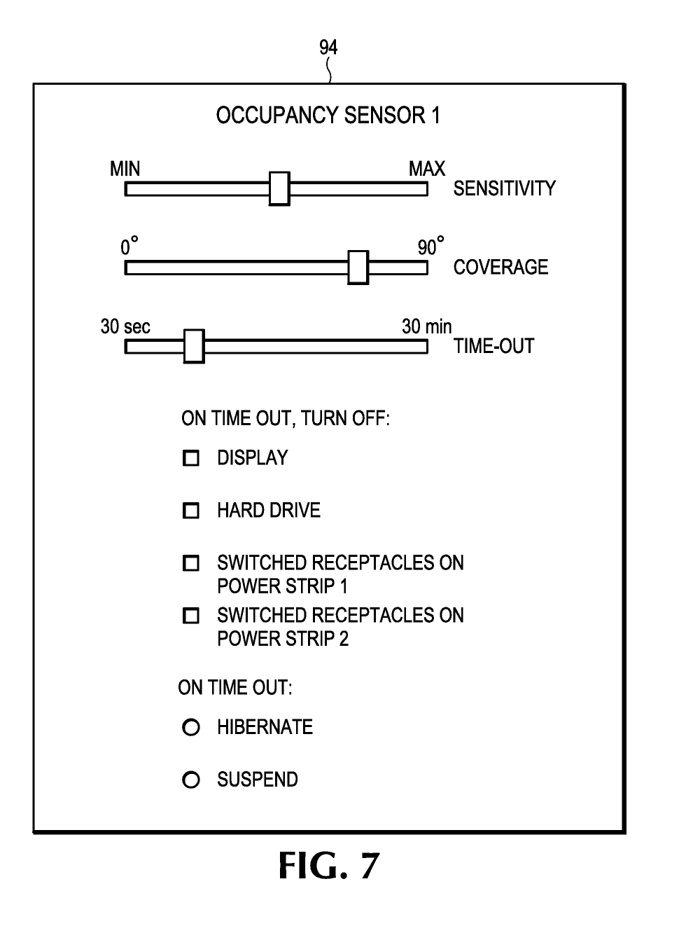

FIG. 7 illustrates an embodiment of a dialog box for implementing a user interface according to some inventive principles of this patent disclosure. The dialog box 94 includes graphical “slider bars” for setting the sensitivity, field of coverage (in terms of viewing angle) and time-out delay for an occupancy sensor that is capable of receiving adjustable parameters. The dialog box also includes check boxes to specify which internally controlled hardware such as displays (monitors) and hard drives, as well as which externally controlled hardware such as power strips, should be turned off in response to the occupancy sensor. Another check box may be included to specify if the workstation CPU should be placed in a low power mode, and if so, graphic radio buttons may also be included to indicate the type of low power mode such as sleep, hibernate, standby, etc.

Some additional functionality may include advanced screens, and device-specific configuration controls configuring the number of sensors, switching priority for switching devices such as power strips, ability to auto-detect power strips, load monitoring functions, data logging, etc.

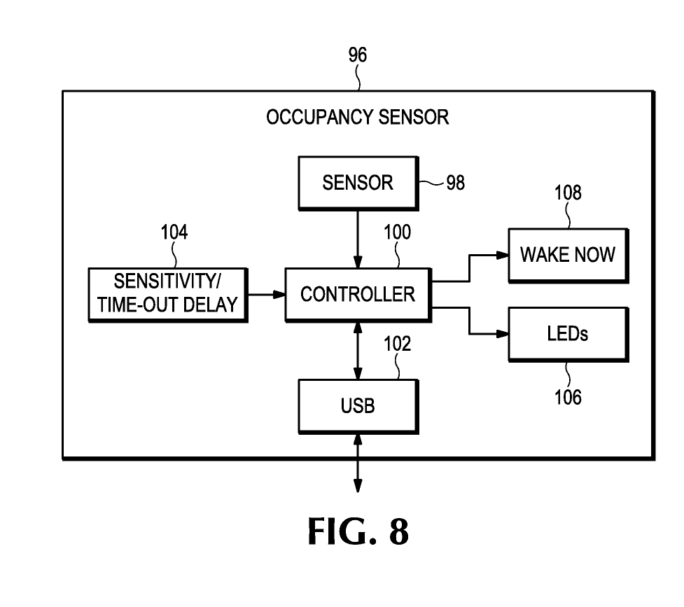

FIG. 8 is a block diagram of an embodiment of an occupancy sensor according to some inventive principles of this patent disclosure. The occupancy sensor 96 includes one or more sensors 98 based on any suitable sensing technology or technologies. A controller 100 processes raw signals from the one or more sensors 98 and generates an occupancy signal which is transmitted through a USB port 102. Conventional sensitivity and time-out delay controls 104 may be included to enable the controller to adjust the occupancy sensor for the specific space it is configured to monitor. Alternatively, or additionally, the controller may adjust the occupancy sensor in response to adjustable parameters that it receives through the USB port 102. One or more indicators 106 may be included to display the occupied/unoccupied status as determined by the occupancy sensor. For example, a tri-color LED may be configured to display red for an unoccupied condition, green for an occupied condition, and yellow for a fault condition. A “wake now” input enables a user to take the system out of unoccupied mode if the sensor does not detect when the user returns to the workstation. Electronics in the occupancy sensor or application software in the workstation may increase the sensitivity setting of the occupancy sensor each time the wake now button is pressed, since this may indicate that the sensitivity setting is too low.

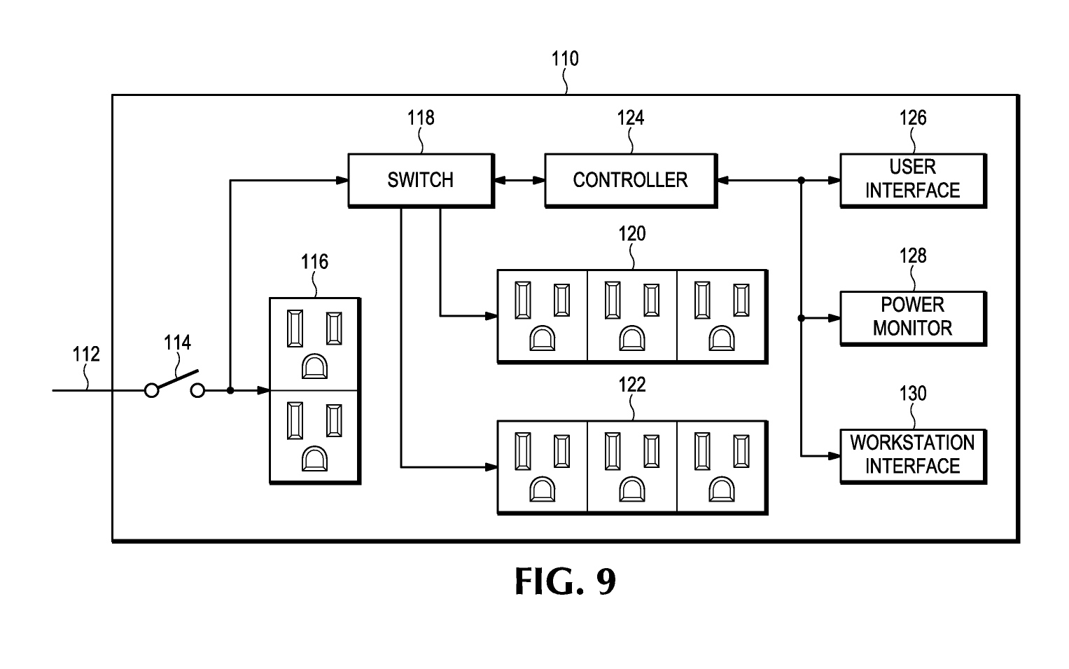

FIG. 9 is a block diagram of an embodiment of a power strip according to some inventive principles of this patent disclosure. The power strip 110 of FIG. 9 receives input power from a connection 112 which may include a plug-and-cord assembly, connector prongs to plug directly into a receptacle, etc. A main switch and/or circuit breaker and/or surge arrestor 114 receives the input power which is distributed directly to a first set of receptacles 116 that are energized when the power switch 114 is closed. The power is also applied to a switch circuit 118 that controls the flow of power to a second set of receptacles 120 and a third set of receptacles 122. A controller 124 controls the switch circuit 118 and communicates with a user interface 126, a power monitor circuit 128 and a workstation interface 130.

The workstation interface 130 enables the power strip to communicate with a workstation through a wired or wireless connection using any suitable interfacing arrangement. Some suitable examples of a wired interface include USB, IEEE1493, RS232, Ethernet, etc., while examples of wireless interfaces include interfaces compatible with standards from Bluetooth, EnOcean, Zig-Bee, Wi-Fi, etc.

The power monitor circuit 128 may include any suitable circuitry to monitor the voltage, current, power, etc., of any load connected to any of the switched or unswitched receptacles. In some embodiments, a commercially available meter chip may be used along with a current sense transformer and voltage sense leads to provide a low-cost solution that may be easily integrated into the power strip.

The user interface 126 may include any type of inputs and/or outputs to enable a user to configure and/or control the power strip, enter parameters, check the status or performance history of the power strip, etc., from the power strip itself. The user interface may include one or more input devices such as a potentiometer or other analog input, digital switches of any type including DIP switches, toggle switches, rotary switches, etc. The user interface may include one or more output devices such as lights, LEDs, numeric displays, alphanumeric displays, dot-matrix displays, etc. The user interface may be configured to enable a user to set one or more time delays that control the operation of the switching circuit as described below, as well as communication protocols, and/or additional time delay, and/or any other parameters.

The communications with the workstation may be only one-way to control one or more sets of switched receptacles, or bi-directional to enable reporting of power monitoring data to the workstation. The communications may also enable a user to configure and/or control the power strip, enter parameters, check the status or performance history of the power strip, etc.

In some embodiments, the controller 124 in the power strip may be configured to turn both sets of switched receptacles 120 and 122 on or off at the same time as soon as it receives a command from the workstation. In other embodiments, the controller may delay turning one of the two sets on or off to avoid power fluctuations, surges, etc. Alternatively, the different sets of switched receptacles 120 and 122 may be controlled by different commands from the workstation which may include logic for staggering load turn-on and turn off, or for controlling the two sets of receptacles differently in response to different occupancy conditions at the workstation. For example, different loads may be turned on or off in response to different occupancy sensors in a multi-sensor arrangement as described below.

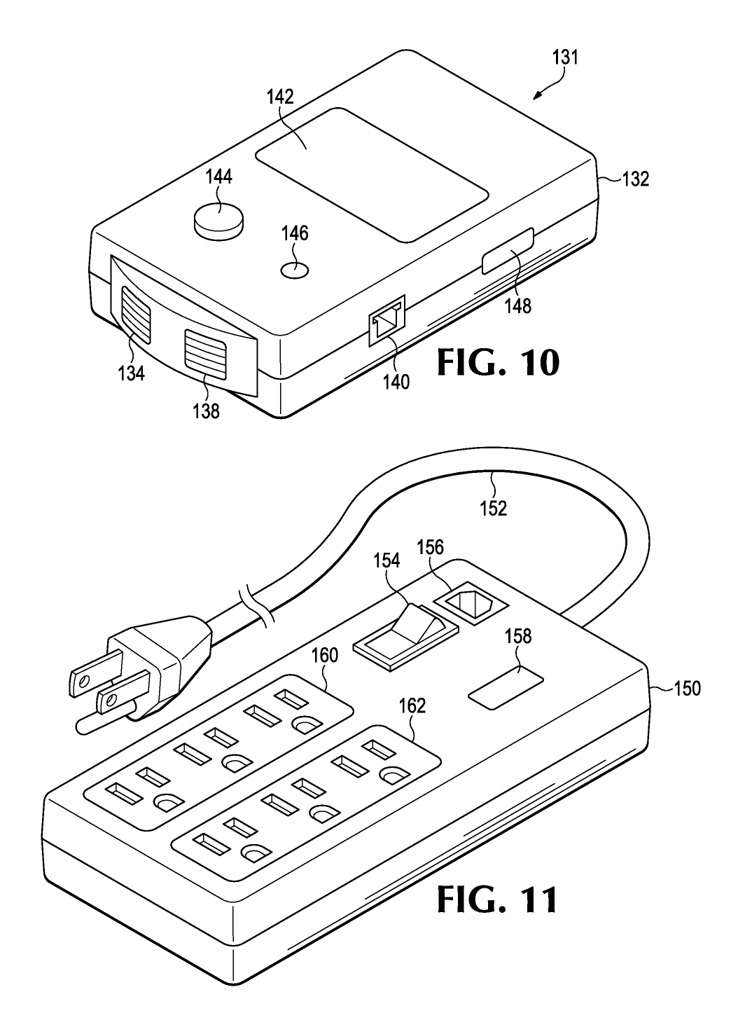

FIG. 10 is a perspective view of an example embodiment of an occupancy sensor according to some inventive principles of this patent disclosure. The embodiment of FIG. 10 may be used, for example, to implement embodiment of FIG. 8. The occupancy sensor of FIG. 10 includes a compact housing 132 to facilitate easy mounting on a workstation display. The front of the housing includes two ultrasonic transducers 134 and 138 that are mounted on a convex surface to provide a defined coverage pattern (field of “view”) for ultrasonic occupancy sensing. A mini USB port 140 enables the use of a standard USB cable to connect the occupancy sensor to a USB port on the workstation. A removable panel 142 conceals standard control dials for sensitivity and time-out delay settings. A pushbutton 144 may be used to implement the “wake now” feature described above. A multi-color LED 146 provides feedback that indicates whether the occupancy sensor is detecting an occupied or unoccupied state, a fault condition, etc.

In some embodiments, the coverage pattern of the occupancy sensor may be adjusted by disabling one of the transducers, or by providing different weighting to the outputs from the transducers to implement a beam forming technique. A user may specify the desired field of view, for example, through a control panel or dialog box such as that shown in FIG. 7.

The occupancy sensor of FIG. 10 may be mounted in any suitable location using any suitable technique such as clips, magnets, two-sided tape, hook-and-loop fasteners such as Velcro, etc. In some embodiments, a dedicated communication cable for connecting to a workstation may be permanently attached to the housing using a strain relief. Alternatively, or in addition to a USB port or permanent cable, a wireless interface using radio frequency (RF) or infrared (IR) technology may be included for communication with the workstation. An Infrared Data Association (IrDA) compatible interface 148 is shown in FIG. 10 to implement IR communications. RF communication may be accomplished with an antenna that is internal to the housing if the housing is made from plastic.

FIG. 11 is a perspective view of an example embodiment of a power strip according to some inventive principles of this patent disclosure. The embodiment of FIG. 11 may be used, for example, to implement the embodiment of FIG. 9. The power strip of FIG. 11 includes a housing 150, a plug-and-cord assembly 152, a main power switch 154, an IrDA receiver 158, and a type-B USB port 156 for connecting the power strip to a computer or other equipment. Two sets of receptacles 160 and 162 are de-energized when the main power switch 154 is in the OFF position. When the main power switch 154 is in the ON position, a first set 160 of the receptacles is constantly energized, while the second set 162 of the receptacles is energized or de-energized in response to commands received from a workstation through the USB port 156 or the IrDA port 158.

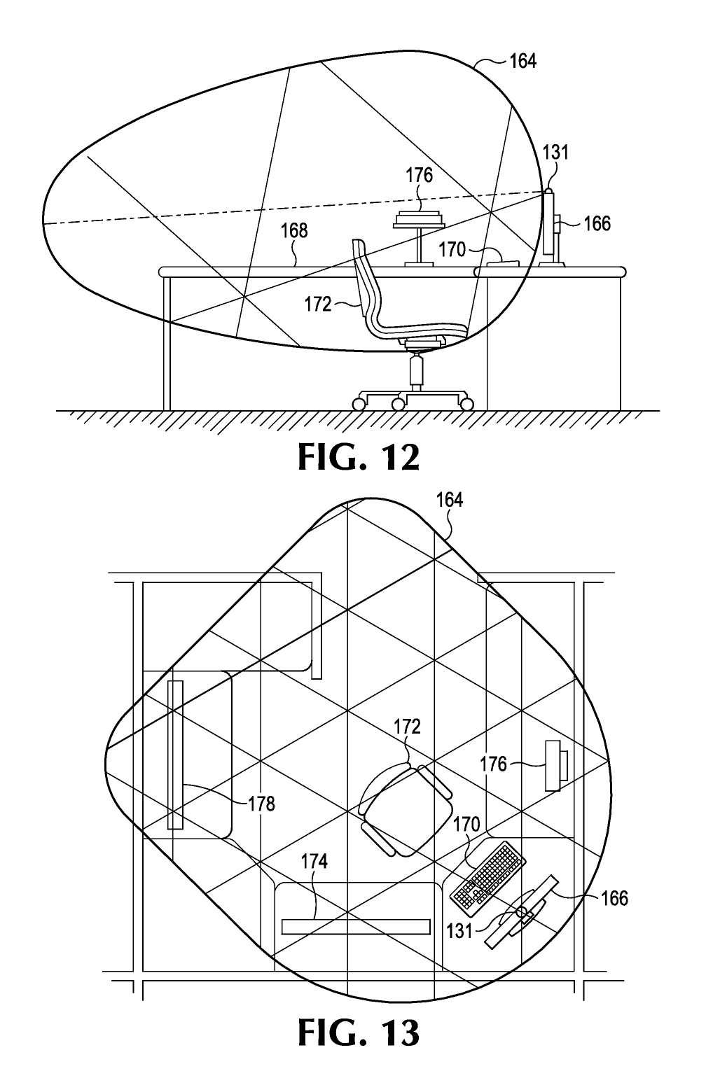

FIGS. 12 and 13 illustrate a side elevation view and a top plan view, respectively, of an example of the coverage pattern 164 that may be achieved with the occupancy sensor of FIG. 10. The occupancy sensor 131 is mounted to the top of a workstation display 166 that is situated on a desk 168. In this example, the workstation CPU is included in the display 166 and is controlled by keyboard 170. As seen in FIGS. 12 and 13, the coverage pattern 164 includes the user's chair 172 and other areas associated with the workstation that the user is likely to occupy while actively working at the workstation. These areas include a printer 174, a task lamp 176 and a space heater 178. The coverage pattern is typical of the pattern that may be achieved with a two-transducer ultrasound system. This pattern may be altered by turning off or weighting the outputs from one or more of the transducers as described above, or by using other occupancy sensing technologies.

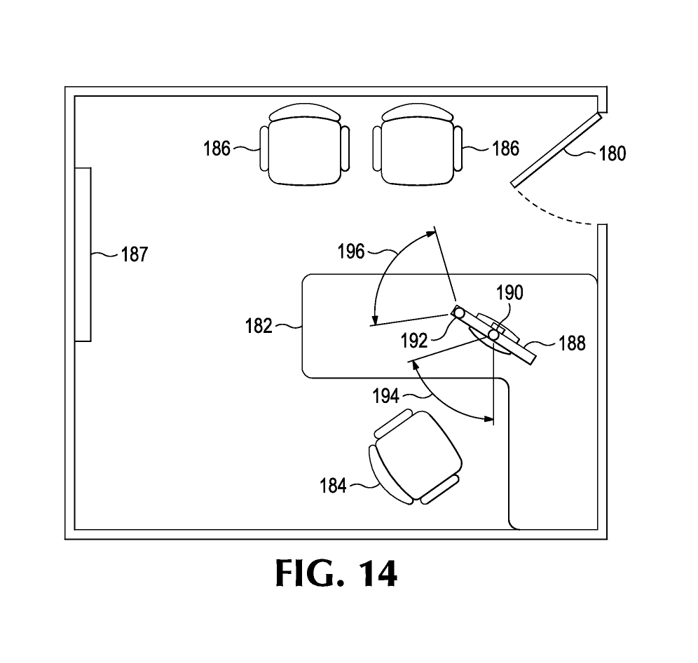

FIG. 14 is a top plan view of a workspace associated with another embodiment of a workstation occupancy sensing system according to some inventive principles of this patent disclosure. The workspace of FIG. 14 is an office having a door 180, a desk 182, a chair 184 for the office's main occupant, visitor chairs 186, and a whiteboard 187. A workstation display 188 has two occupancy sensors 190 and 192 that are mounted on top of the display and connected to the workstation through USB cables or other types of connections as described above. The first occupancy sensor 190 has a coverage pattern 194 that is generally intended to include only the space that is likely to be occupied by the main occupant of the office while working alone. The second occupancy sensor 192 has a coverage pattern that includes the visitor chairs 186 and whiteboard 187 which are likely to be occupied when the main occupant has visitors, or when the main occupant enters the office through the door 180.

Both of the occupancy sensors 190 and 192 may be connected to the workstation and configured and operated as described in the context of systems having a single occupancy sensor as described above, but with separate settings and actions defined for each occupancy sensor. For example, room lighting or space heating in the office maybe turned on in response to either of the two occupancy sensors detecting an occupied condition, whereas the display, and any task lighting, printer, or other peripherals located on the desk 182 may only be controlled in response to the occupancy sensor 190 having the coverage pattern 194 that includes the desk area.

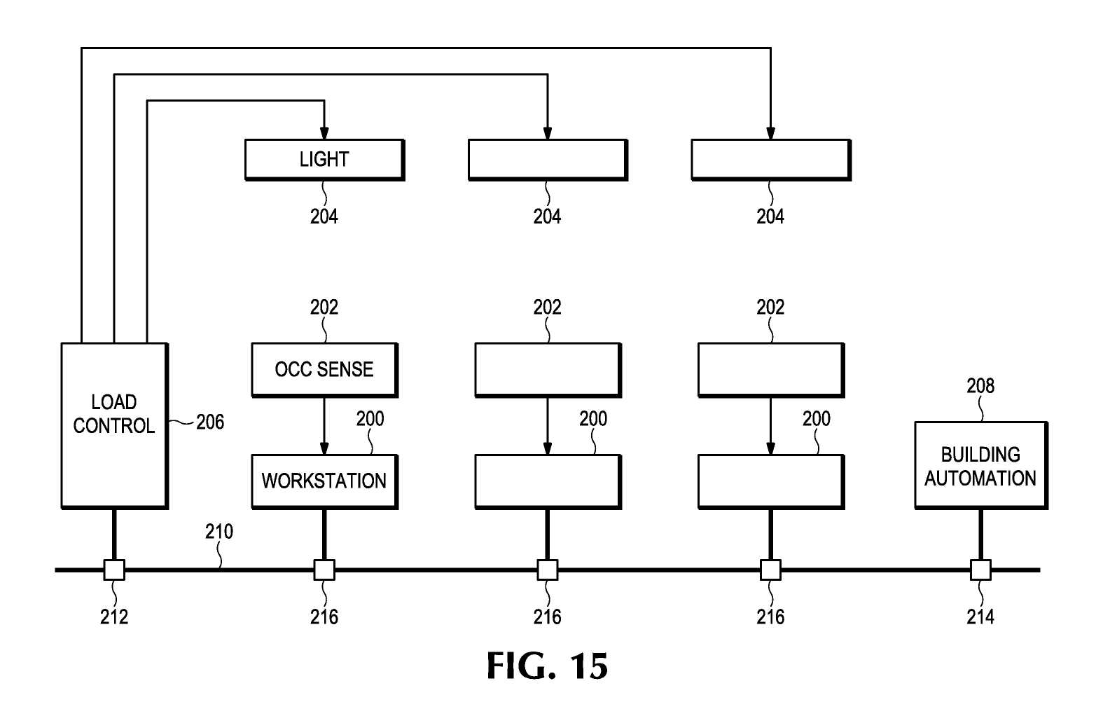

FIG. 15 illustrates another embodiment of an occupancy sensing system according to some inventive principles of this patent disclosure. The embodiment of FIG. 15 includes multiple workstations 200, each workstation having an occupancy sensor 202 connected to the workstation using any of the techniques described above. Each workstation also has at least one building light fixture 204 that illuminates the space associated with the corresponding workstation. The flow of power to the building lights is controlled by a load control device 206 in response to commands received from a building automation server, workstation, or other controller 208. The load control device 206 and building automation or lighting system controller 208 and workstations 200 are connected to a building network 210 through network adapters 212, 214 and 216, respectively, as well as their own individual network interface cards. The building network 210 may be implemented with Ethernet, CAN or other type of network suitable for building automation, energy management, etc. The load control device may be implemented with a relay cabinet, dimmer rack, distributed relay/dimmer system, etc., or any other network connected load control device.

The building automation controller 208 provides the overall operational logic for the system. When the controller 208 receives a message from one of the workstations indicating that the associated occupancy sensor has detected an unoccupied condition for the associated space, it issues a command to the relay cabinet instructing it to turn off the light for the space associated with that workstation. Upon receiving an indication from a workstation that the associated space is once again occupied, the controller signals the relay cabinet to restore power to the light for that space.

A potential advantage of the system illustrated in FIG. 15 is that it may enable lighting and other building automation systems to better accommodate occupants in cubicles or other relatively small spaces. Traditional lighting control systems and other building automation systems typically employ ceiling or wall mounted occupancy sensors. Cubical spacing requires more densely placed sensors with proper alignment complicated by the location of overhead lighting fixtures, heating ventilation and air conditioning (HVAC) equipment, sprinklers, etc. Moreover, the frequent rearrangement that is common with cubical spaces presents a further challenge to proper alignment of occupancy sensors. The inventive principles relating to workstation-based occupancy sensor systems described in this patent disclosure, however, may reduce or eliminate these problems because the occupancy sensor for each workstation and its associated workspace may be positioned very easily in a close location that reliably monitors the area most likely to be occupied by the workstation user. Moreover, the inventive principles may reduce the cost and uncertainty associated with mounting numerous occupancy sensors on ceilings or walls of buildings.

In embodiments in which a workstation is networked to a lighting control system or other building automation system, the application software may implement a blink warning override feature. For example, the lighting control system may be configured to turn off the lights in a building space in response to a timer-based energy conservation schedule. In such a configuration, the lighting control system typically turns the lights off briefly (a “blink warning”) prior to actually turning off the lights to notify occupants of the impending automated turn-off. After the blink warning, the lights are held on long enough to allow occupants to leave the area or input a request to the lighting control system to keep the lights on. Inputting a request typically requires the occupant to find a control station for the lighting control system. The nearest control station may be a considerable distance from the occupant's workstation.

According to some inventive principles of this patent disclosure, the application software may automatically notify the lighting control system that the space associated with the workstation is occupied, and therefore, automatically override the blink warning for the light or lights that illuminate the space associated with the workstation. Alternatively, or in addition, the application software may receive a message from the lighting control system when a blink warning is imminent, and present a pop-up message or dialog box to the occupant advising the occupant of the impending blink warning. This may simply notify the occupant of the blink warning event, or the occupant may then be allowed to elect through the workstation to override the blink warning, or to allow the blink warning to proceed as normal.

In embodiments in which a workstation is networked to a lighting control system or other building automation system, the application software may also provide other override features. For example, if the lighting control system is configured to turn off the lights in a building space in response to a timer-based energy conservation schedule, the application software may request that the lighting control system maintain the lighting in the space associated with the workstation, regardless of any blink warn functionality. The maintained lighting may include not only the space associated with the workstation, but also any related areas to allow for egress from the space.

The application software may also be configured to allow or override an attempt by a networked building automation system to sweep off power receptacles in the space associated with the workstation if the occupancy sensor indicates that the space is occupied. The sweep-off functionality may be integrated with, or separate from the blink warning override functionality.

In embodiments in which a workstation is networked to a lighting control system or other building automation system, the application software may also provide load monitoring data to the control or automation system if there is any load monitoring apparatus connected to the workstation. This may enable the lighting control system or other building automation system to evaluate the effectiveness of the occupancy sensing and load control functionality of the workstation-based occupancy sensing systems, as well as their interaction with other building automation systems.

In locations where a handheld or other remote control is used for local control of lights in a lighting control system or other building automation system, a workstation having an occupancy sensor connected may be further connected to the remote control as a way to interface the workstation to the control or automation system. For example, an existing handheld remote control may provide on/off and dimming control of overhead lights through an IR receiver in a digital wall switch or photocell device. An additional wired or wireless connection may be created between the handheld remote and the workstation to enable the workstation to control the lighting in response to the occupancy sensor through the handheld remote, thereby eliminating the need for a network connection between the workstation and the lighting control system or building automation system. Alternatively, a wireless connection may be created directly between the workstation and the receiver that is used by the handheld remote, thereby allowing the workstation to communicate directly with the lighting control system through the existing system components and without the need for an additional network connection.

The methods and apparatus described above enable the implementation of countless features according to the inventive principles of this patent disclosure. Some example implementation details are described below to illustrate the many features and benefits that may be realized. The inventive principles, however, are not limited to these example details.

Although any suitable occupancy sensing technology, or combination thereof, may be utilized, ultrasonic sensing may be particularly well suited to the small spaces and small motion that may need to be detected for occupants performing office work in a cubicle. For example the use of two ultrasonic transducers as shown in FIG. 10 may produce a coverage pattern as shown in FIG. 13 and provide roughly 90 square feet of coverage which may be ideal for many cubicle or small office applications.

Mounting the one or more occupancy sensors on a workstation display may provide ideal converge because workstation users typically arrange their entire workspace around the display. Other possible mounting locations include desktops or the under side of desk surfaces, file cabinets, overhead storage cabinets, other peripherals such as printers, cubicle walls, task light fixtures, etc.

Using an occupancy sensor that generates a conventional occupancy signal that provides a binary occupied/unoccupied indication may simplify implementation and enable the use of existing occupancy sensing circuitry which has been subjected to extensive troubleshooting, fine tuning and cost reduction. However, other types of occupancy sensors that provide more raw output such as the unprocessed output from an ultrasound transducer or infrared pyrometer may be used, and the computing power of the workstation may be used to process the raw output to make the occupied/unoccupied determination.

The occupancy sensors may include onboard electronics that are only sufficient to adjust the sensitivity and time-out delay based on local inputs at the occupancy sensor, or the electronics may be able to adjust the occupancy sensor in response to adjustable parameters that are input by a workstation user through a pop-up or control panel and transmitted through a USB or other wired or wireless connection.

Power strips having multiple switched and unswitched power receptacles may provide an ideal platform to switch power to external workstation peripherals such as task lighting, printers, space heaters, etc., in response to an occupancy sensor coupled to the workstation. However, other power switching platforms may be used including single-receptacle plug-in modules that plug directly into a wall outlet without a power cord and communicate with the workstation through a wired or wireless connection such as a Bluetooth wireless interface. Other examples include building wiring devices such as wall outlets that have switched receptacles and communicate with the workstation through a wired or wireless connection.

One type of power strip may include a USB connection to the workstation with a mix of switched and unswitched receptacles as shown in FIGS. 9 and 11. Another type of receptacle may not have a connection to the workstation, but instead may be connected directly to the occupancy sensor through a wired or wireless connection. Such an embodiment may have built in sensitivity and time-out delay functionality and may include user inputs to adjust these parameters.

The application software for the workstation may be written for any suitable platform including personal computer platforms such as Microsoft Windows, Apple OS X, as well as other platforms such as UNIX, Linux, etc.

In embodiments in which a workstation may be placed in a standby or hibernate mode when the space associated with the workstation is unoccupied, the power for the USB or other connection to the occupancy sensor may be turned off. Therefore, the workstation operating system may need to be configured to wake when it receives a signal on the USB or other connection.

The inventive principles of this patent disclosure have been described above with reference to some specific example embodiments, but these embodiments can be modified in arrangement and detail without departing from the inventive concepts. For example, some of the embodiments described above are illustrated in the context of lighting control systems, but the inventive principles may be applied to HVAC systems, security systems, etc. As a further example, much of the functionality in the embodiments described above is described in the context of a software implementation, but any of the functionality may also be implemented with analog and/or digital hardware, software, firmware, or any suitable combination thereof. Such changes and modifications are considered to fall within the scope of the following claims.

1. A method comprising:
providing an occupancy sensor coupled via a connection to a computer workstation;
monitoring a space associated with the computer workstation with the occupancy sensor;
generating an occupancy signal in response to monitoring the space;
transmitting the occupancy signal to the computer workstation;
processing the occupancy signal with a central processing unit of the computer workstation; and
performing one or more power management functions at the computer workstation in response to the occupancy signal.

2. The method of claim 1 where the one or more power management functions comprises an internal power management function, which comprises at least one of turning off a display of the computer workstation, turning off a hard drive of the computer workstation, turning off the central processing unit of the computer workstation, and putting the workstation in a sleep mode.

3. The method of claim 1 where the connection between the occupancy sensor and the computer workstation is a hard wire.

4. The method of claim 1 where the connection between the occupancy sensor and the computer workstation is via a wireless connection.

5. The method of claim 1 where performing the one or more power management functions comprises controlling a power switch coupled via a connection to the computer workstation.

6. The method of claim 1 where the occupancy signal is received by the computer workstation through a USB port.

7. The method of claim 1 where the one or more power management functions comprises an external power management function.

8. The method of claim 7 where the external power management function comprises turning off power to an electrical receptacle.

9. The method of claim 8 where the electrical receptacle is included in a power strip.

10. The method of claim 7 where the external power management function comprises controlling a peripheral device having built-in power management capability.

11. The method of claim 7 where the external power management function comprises communicating with a building automation system.

12. The method of claim 11 where communicating with the building automation system comprises requesting the building automation system to turn off lighting for the space associated with the computer workstation.

13. The method of claim 1 where the space associated with the computer workstation is monitored by an occupancy sensor mounted to a display for the computer workstation.

14. The method of claim 1 where:
the occupancy sensor comprises two or more ultrasonic transducers; and
the method further comprises providing different weighting to outputs from the transducers, thereby adjusting the coverage pattern of the occupancy sensor.

15. The method of claim 1 further comprising adjusting a parameter of the occupancy sensor at the computer workstation.

16. The method of claim 1 further comprising monitoring data via a load monitoring apparatus coupled to the computer workstation via a connection.

17. The method of claim 15 where the parameter of the occupancy sensor is adjusted through a dialog box at the computer workstation.

18. A method comprising:
monitoring a space associated with a computer workstation using an occupancy sensor coupled to the computer workstation;
generating an occupancy signal in response to monitoring the space;
processing the occupancy signal at the computer workstation; and
adjusting the occupancy sensor from the computer workstation.

19. The method of claim 18 further comprising performing one or more power management functions at the computer workstation in response to the occupancy signal.

20. The method of claim 18 where adjusting the occupancy sensor from the computer workstation comprises:
receiving input from a user at the workstation;
adjusting a parameter of the occupancy sensor in response to the input; and
transmitting the adjusted parameter from the workstation to the occupancy sensor.

21. The method of claim 18 where the parameter comprises sensitivity for the occupancy sensor.

22. The method of claim 18 further comprising:
receiving a wake input at the occupancy sensor; and
transmitting the wake input to the workstation.

23. The method of claim 22:
where the parameter comprises a sensitivity for the occupancy sensor; and
further comprising increasing the sensitivity for the occupancy sensor in response to receiving the wake input.

24. A method comprising:
monitoring a space associated with a computer workstation for an occupant;
generating an occupancy signal in response to monitoring the space;
transmitting a request from the computer workstation to a building automation system in response to the occupancy signal; and
performing one or more power management functions with the building automation system in response to the request from the computer workstation.

25. The method of claim 24 where the one or more power management functions includes controlling a light for the space associated with the computer workstation.

26. The method of claim 25 further comprising overriding a blink warn operation in response to the request.

27. The method of claim 24 further comprising overriding a sweep operation in response to the request.
